(19) United States
(12) Patent Application Publication
(10) Pub. No.: US 2011/0072871 A1
(43) Pub. Date: Mar. 31, 2011

(54) WATER SOLUBLE ALKYD RESIN-SULFUR COATED CONTROLLED RELEASE FERTILIZER AND PREPARATION THEREOF

(75) Inventors: Hongkun Chen, Shandong (CN); Lianbu Wan, Shandong (CN); Lingchao Fan, Shandong (CN); Hengjun Xu, Shandong (CN); Huaisheng Cao, Shandong (CN)

(73) Assignee: SHANDONG KINGENTA ECOLOGICAL ENGINEERING CO., LTD., SHANDONG (CN)

(21) Appl. No.: 12/995,460

(22) PCT Filed: May 30, 2008
(86) PCT No.: PCT/CN08/01066

§ 371 Date: Nov. 30, 2010

(51) Int. Cl. C05F 11/00; C08K 5/06; B05D 7/00

(52) U.S. Cl. 71/23; 71/27; 524/377; 427/213

(57) ABSTRACT

The invention relates to a water-soluble alkyd-sulfur composite coated controlled-release fertilizer and method of preparing the same. The coated controlled-release fertilizer comprising a fertilizer core and a coating applied thereon, wherein said coating comprises a sulfur film and a polymer film comprising a coating agent of water-soluble alkyd outside the sulfur film, and optionally an inorganic layer comprising inorganic powder outside the polymer film.

### BACKGROUND OF THE INVENTION

The invention relates to a coated controlled-release fertilizer, and more particularly to a water-soluble alkyd-sulfur composite coated controlled-release fertilizer and a preparation method of the above-mentioned coated controlled-release fertilizer, which belong to the field of material and fertilizer.

Slow/controlled release fertilizers represent the developing direction of fertilizer industry; especially controlled-release fertilizers with good properties have been widely concerned. The sulfur-coated urea with sulfur as a coating agent is a kind of slowly-releasing fertilizer, which is earlier industrialized, and the technology of its preparation has been described in such patents as U.S. Pat. No. 3,295,950, U.S. Pat. No. 3,342,577, U.S. Pat. No. 3,877,415. The preparation of sulfur-coated fertilizer is commonly carried out on a fluidized bed, the process of which is as follows: firstly fertilizer particles are preheated to certain temperature on a fluidized bed, and then the molten liquid sulfur is sprayed on the fertilizer particles with a nozzle. Because the temperature of the surface of particles is lower than the crystallization temperature of sulfur, liquid sulfur solidifies once contacting the surface of particles, and a continuous sulfur film forms on the surface of said fertilizer particles eventually. As sulfur-coated fertilizer has good slow-releasing properties and its production technology is simple, and sulfur is very cheap, such industrial products of sulfur-coated fertilizer have been widely applied. However, because of the intrinsic brittleness of sulfur and poor performance in impact resistance and abrasion resistance of the coating of sulfur, the sulfur film is very easily destroyed during the production, packing, transportation and storing of sulfur-coated fertilizer. Consequently, the slow-releasing properties of such products recede signally. In addition, as the melting point of sulfur is higher and the uniformity of the sulfur film is hard to be controlled during the production process, the coating of some particles in the product is too thin or a continuous film is not even existent. Researches show that the nutrient release of sulfur-coated fertilizer includes two approaches: nutrient diffusion through defective points of the coating and collapsing of the sulfur coating, however, the diffusion through defective points of the coating apparently leads to quick release of nutrient. Although defective points of the coating can be controlled by adjusting its thickness, more sulfur is usually required spraying to obtain the desired effect. Consequently, sulfur-coated fertilizer is a kind of slow-release fertilizers, which performs relatively poorly in controlled-release of plant nutrient.

In order to provide sulfur-coated fertilizer with better impact strength and controlled-release properties, the multilayer composite coated controlled-release fertilizer has appeared (referring to U.S. Pat. No. 3,991,225, U.S. Pat. No. 5,219,465). Such products aim to overcome the defects of sulfur-coated layer by coating a layer of sealant on the surface of sulfur-coated fertilizer, and sealants commonly used include organics such as paraffin and polyolefin. Because these said sealants are adhesive, it still requires coating another layer of regulator on the surface that is sealed.

The above-mentioned defects of sulfur-coated fertilizer can be overcome by resin-coated controlled-release fertilizer, and relevant patents are referred to U.S. Pat. No. 3,223,518, U.S. Pat. No. 3,475,154, U.S. Pat. No. 4,019,890, U.S. Pat. No. 4,804,403 and WO 02/00573. The usual preparation method of said controlled-release fertilizer is as follows: firstly a kind of polymer is dissolved in an organic solvent; then the said solution is sprayed on the fertilizer particles, and a uniform and continuous polymer film with good abrasion resistance and impact resistance forms after the solvent volatilizes completely. As the nutrient release of the controlled-release fertilizer is mainly through the diffusion of film, the component and structure of the polymer film can be designed to make the law of nutrient release of said fertilizer match with that of nutrient demand of plant. Nevertheless this kind of controlled-release fertilizer has shortcomings including: the cost of the coating material of resin is high; the use of a large amount of organic solvent certainly leads to the waste of the energy and resource, and endangers the environment and human health simultaneously.

Consequently, it is always a focus to develop a kind of coated fertilizer, which has low cost as sulfur-coated fertilizer and good abrasion-resistance, impact-resistance and controlled-release properties as polymer-coated fertilizer in the controlled-release fertilizer field.

### BRIEF SUMMARY OF THE INVENTION

In view of the existent problems of controlled-release fertilizers, one objective of the invention is to provide an eco-friendly polymer-sulfur composite coated controlled-release fertilizer. Wherein the polymer coating agent mainly uses water as the medium and the polymer film formed is biodegradable, which greatly reduces the damage of organic solvent-based polymer coating agent to human and environment and meanwhile the cost of polymer coating agent. Besides, coated controlled-release fertilizer obtained has good controlled-release properties.

To achieve the above objective, there is provided a water-soluble alkyd-sulfur composite coated controlled-release fertilizer comprising a fertilizer core and a coating applied thereon, wherein said coating comprises a sulfur film and a polymer film comprising a coating agent of water-soluble alkyd outside the sulfur film, and optionally an inorganic layer comprising inorganic powder outside the polymer film.

Another objective of the invention is to provide a method of preparing the said polymer-sulfur composite coated controlled-release fertilizer, which includes the following coating process: firstly coating the surface of fertilizer particle with sulfur to form a sulfur film; then coating the surface of said sulfur film with a coating agent of water-soluble alkyd to form a polymer film, and optionally coating said polymer film with inorganic powder to form an inorganic layer.

Because the interior coating layer is consisted of low-cost sulfur and thereon the low-cost polymer film is formed by a water-soluble alkyd coating agent, said water-soluble alkyd-sulfur composite coated controlled-release fertilizer in the invention has both the advantages of sulfur-coated fertilizer and polymer-coated fertilizer.

The coated controlled-release fertilizer of the invention, as the water-soluble alkyd coating agent used is with water as the medium, overcomes many defects of the coated controlled-release fertilizer using a solvent-based polymer coating agent. Compared with other synthetic resins, the alkyd in the invention whose primary raw material derives from renewable vegetable oil of nature, relies little on petroleum and is biodegradable, in addition to low-cost and renewable. Hence, the water-soluble alkyd-sulfur composite coated controlled-release fertilizer of the invention is characterized with low cost, good properties of anti-impact and anti-wear, and controlled release. Besides, it has other advantages: it causes little pollution during the production process, nontoxic and no pollution in use; the residues of polymer film could be biodegraded, and the manufacturing techniques are simple.

In addition, in the further preferred embodiment of the invention, said water-soluble alkyd-sulfur composite coated controlled-release fertilizer also contains an outmost layer comprising inorganic powder. In the preferred embodiment, the inorganic layer comprising inorganic powder as the outmost layer is not only anti-stick and anti-wear, but also partly regulates the release of the nutrient.

### BRIEF DESCRIPTION OF THE DRAWINGS

FIG. 1 is the section view of the water-soluble alkyd-sulfur composite coated controlled-release fertilizer according to one embodiment of the invention. It comprises a core consisted of fertilizer particle, a sulfur film coated thereon, and a polymer film coated on the sulfur film layer.

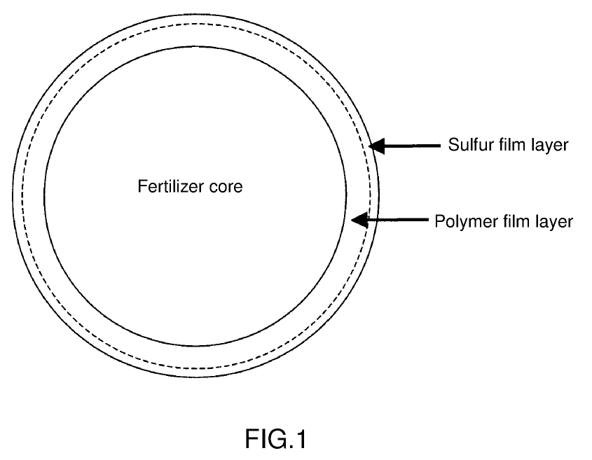

### DETAILED DESCRIPTION OF THE INVENTION

The preparation process of said water-soluble alkyd-sulfur composite coated controlled-release fertilizer in present invention includes preparation of water-soluble alkyd coating agent and coating of fertilizer. The primary raw material of said water-soluble alkyd coating agent in present invention is the prepolymer of alkyd. In the detailed embodiments of present invention, the prepolymer of alkyd is firstly prepared; then said prepolymer of alkyd is mixed with the cosolvent; afterwards the mixture obtained is neutralized with the alkali and optionally diluted with water, and the drier is added. The coating agent of water-soluble alkyd is obtained at last.

(1) Preparation of the Prepolymer of Alkyd

The prepolymer of alkyd used in present invention is preferably obtained through the copolycondensation of the raw material composition comprising vegetable oil and/or fatty acid derived from plant, polyalcohol and at least one component selected from C₄-C₂₂ synthetic fatty acid, anhydride of C₄-C₂₂ synthetic fatty acid, aromatic acid, and aromatic anhydride.

In the preferred embodiment of the invention, the vegetable oil for preparing the prepolymer of alkyd is selected from drying oil, semi-drying oil, or a mixture thereof, which contains linseed oil, tung oil, dehydrated castor oil, soybean oil, cottonseed oil and Naskole oil, etc.. Said fatty acid derived from plant is selected from oleic acid, linoleic acid, linolenic acid, tall oil, rosin, or a mixture thereof. Because some fatty acids, such as oleic acid, linoleic acid, linolenic acid, etc., are derived from grease, these fatty acids can be obtained on the spot by the alcoholysis of corresponding grease in the practical operation. Said polyalcohol is selected from glycerine, trimethylolpropane, pentaerythritol, sorbitol, diethylene glycol, or a mixture thereof, preferably glycerine, trimethylolpropane and pentaerythritol. The preferred carbon number of said C₄-C₂₂ synthetic fatty acid and their anhydride is 4-22, and the C₄-C₁₂ monoacid or polyacid or their anhydride are preferred, such as maleic acid, maleic anhydride, fumaric acid, caproic acid, capric acid, adipic acid, decanedioic acid, more preferably C₄-C₂₂ diacid and their anhydride, especially adipic acid, decanedioic acid and their anhydride. Said aromatic acid and their anhydride are preferably selected from the group consisting of aromatic monoacid, aromatic diacid, aromatic triacid and their anhydride, which contain benzoic acid, phthalic acid, phthalic anhydride, isophthalicacid, trimellitic acid, trimellitic anhydride, etc., preferably aromatic diacid, triacid and their anhydride, especially phthalic anhydride, isophthalicacid, trimellitic acid and trimellitic anhydride. Said aromatic acid and their anhydride can be unsubstituted, or substituted by one or more substituent groups selected from the group consisting of C₁-C₆ alkyl, C₁-C₆ alkoxyl, C₁-C₆ halogen alkyl, halogen and nitryl. Said halogen is selected from the group consisting of fluorine, chlorine, bromine and iodine. Said alkyl structure of C₁-C₆ alkyl, C₁-C₆ alkoxyl and C₁-C₆ halogen alkyl is the saturated linear chain or branched hydrocarbyl with 1-6 carbon atoms, preferably 1-4, such as methyl, ethyl, propyl, 1-methylethyl, butyl, 1-methylpropyl, 2-methylpropyl, 1,1-dimethylethyl, amyl, 1-methylbutyl, 2-methylbutyl, 3-methylbutyl, 2,2-dimethylpropyl, 1-ethylpropyl, hexyl, 1,1-dimethylpropyl, 1,2-dimethylpropyl, 1-methylamyl, 2-methylamyl, 3-methylamyl, 4-methylamyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 1,1,2-trimethylpropyl, 1,2,2-trimethylpropyl, 1-ethyl-1-methylpropyl, 1-ethyl-2-methylpropyl. Said C₁-C₆ halogen alkyl is the linear chain or branched saturated hydrocarbyl with 1-6 carbon atoms, wherein the hydrogen atoms in these groups can be partly or totally substituted by the above-mentioned halogen atoms, such as chloromethyl, bromomethyl, dichloromethyl, trichloromethyl, fluoromethyl, difluoromethyl, trifluoromethl, chlorofluoromethyl, di chlorofluoromethyl, chlorodifluoromethyl, 1-chloroethyl, 1-bromoethyl, 1-fluoroethyl, 2-fluoroethyl, 2,2-difluoroethyl, 2,2,2-trifluoroethyl, 2-chlorine-2-fluoroethyl, 2-chlorine-2,2-difluoroethyl, 2,2-dichloro-2-fluoroethyl, 2,2,2-trichloroethyl, pentafluoroethyl, etc.. Said C₁-C₆ alkoxyl is the linear chain or branched saturated hydrocarbyl with 1-6 carbon atoms which is connected by the oxygen atom, such as methoxyl, ethyoxyl, OCH₂—C₂H₅, OCH(CH₃)₂, n-butoxyl, OCH(CH₃)C₂H₅, OCH₂—CH(CH₃)₂, OC(CH₃)₃, n-pentyloxyl, 1-methylbutoxyl, 2-methylbutoxyl, 3-methylbutoxyl, 1,1-dimethylpropoxyl, 1,2-dimethylpropoxyl, 2,2-dimethyl-propoxyl, 1-ethylpropoxyl, n-hexyloxyl, 1-methylpentyloxyl, 2-methylpentyloxyl, 3-methylpentyloxyl, 4-methylpentyloxyl, 1,1-dimethylbutoxyl, 1,2-dimethylbutoxyl, 1,3-dimethylbutoxyl, 2,2-dimethylbutoxyl, 2,3-dimethylbutoxyl, 3,3-dimethylbutoxyl, 1-ethylbutoxyl, 2-ethylbutoxyl, 1,1,2-trimethylpropoxyl, 1,2,2-trimethylpropoxyl, 1-ethyl-1-methylpropoxyl, 1-ethyl-2-methylpropoxyl, etc..

The copolycondensation reaction in present invention can be carried out by the copolycondensation method which is known to those skilled in the art. The temperature of the copolycondensation reaction is between 100 and 280° C., preferably between 140 and 250° C.; the time of the copolycondensation reaction is between 1 and 24 hrs, preferably between 4 and 12 hrs. The end point of the copolycondensation and the quality of alkyd obtained are controlled through the acid number of the resin. The acid number of the resin is the milligrams of the KOH consumed for neutralizing 1 g resin (unit: mgKOH/g resin). The acid number of the resin is determined by the mixed solvent of alcohol and ether with equal-volume ratio according to GB/T2895-1982. The inventors find that the acid number of the prepolymer of alkyd influences the properties of the polymer used as a coating agent in the invention. When the formula of polymerization is fixed, with the increase of the acid number of the prepolymer of alkyd, its water-solubility becomes better, while the hydrophilicity of the coating agent formed becomes higher, which makes the controlled-release time of the controlled-release fertilizer shorten. In the invention, it is positive that the acid number of said prepolymer of alkyd is between 10 and 150 mgKOH/g resin, preferably between 20 and 120 mgKOH/g resin, more preferably between 30 and 80 mgKOH/g resin, and most preferably between 40 and 70 mgKOH/g resin.

In the invention, the formation of the raw material composition used for the polymerizaion can be adjusted in large scale as required, wherein the usage amount of the vegetable oil and/or the fatty acid derived from plant and the molar ratio of hydroxyl to carboxyl in the raw material composition can influence the acid number of the prepolymer and the viscosity of the system. The bigger the viscosity number of said prepolymer of alkyd is, the more the cosolvent in the following preparation of the coating agent is used. Preferably, the usage amount of said vegetable oil and/or said fatty acid derived from plant is 30 to 70 wt % of the total weight of said raw material composition, more preferably 40 to 60 wt %. The molar ratio of hydroxyl to carboxyl in the raw material composition is preferably 0.8 to 1.4, more preferably 0.9 to 1.3.

In the invention, the preparation method of said prepolymer of alkyd can be alcoholysis method or fatty acid process, and the main difference between them lies in that the raw material of the fomer is the vegetable oil, while that of the latter is the fatty acid derived from the vegetable oil. The alcoholysis method is preferred in the invention. The copolycondensation can be carried out in the air or in the inert gas, preferably in the inert gas, and the preferred inert gas is the nitrogen. The copolycondensation can be carried out both in the solvent and in the molten state, and the melt copolycondensation is preferred.

(A) Alcoholysis Method

The alcoholysis method used in the invention can be the well-known alcoholysis method to those skilled in the art. In the preferred embodiment, vegetable oil, polyalcohol and at least one component selected from C₄-C₂₂ synthetic fatty acid, anhydride of C₄-C₂₂ synthetic fatty acid, aromatic acid, and aromatic anhydride, are added into an agitated reactor, and allowed to react at the temperature between 100 and 280° C. (preferably between 140 and 250° C.) for 1 to 24 hrs (preferably 4 to 12 hrs). Water generated in the reaction is removed by a dehydrator during the process. The prepolymer of alkyd is obtained after the cooling.

Preferably, vegetable oil, polyalcohol and diacid(and/or their anhydride) are firstly added into an agitated reactor equipped with an stirrer, a reflex condenser, a thermometer and the protection of nitrogen, and heated to the temperature between 160 and 260° C. and allowed to react for 0.5 to 6 hrs (preferably between 200 and 240° C. for 2 to 4 hrs), and then cooled to the temperature between 120 and 200° C. Other polyacid (and/or their anhydride) are added; the resultant mixture is allowed to react for at least 0.5 hrs with heat preservation, and the water generated in the reaction is removed by a dehydrator. Optionally, 2 to 20 wt % (preferably 3 to 10 wt %) of rosin by the total weight of the resin is added when the reactor is cooled to the temperature between 130 and 160° C., and the resultant mixture is allowed to react for 5 mins to 2 hrs at the temperature, preferably 10 mins to 0.5 hrs. The prepolymer of alkyd with certain acid number is obtained after the cooling.

(B) Fatty Acid Process

The fatty acid process used in the invention can be the well-known fatty acid process to those skilled in the art. Preferably, fatty acid derived from plant, polyalcohol and at least one component selected from C₄-C₂₂ synthetic fatty acid, anhydride of C₄-C₂₂ synthetic fatty acid, aromatic acid, and aromatic anhydride, are added into an agitated reactor at first, and allowed to react at the temperature between 100 and 280° C. (preferably between 140 and 250° C.) for 1 to 24 hrs (preferably 4 to 12 hrs). Water generated in the reaction is removed by a dehydrator during the process. The prepolymer of alkyd is obtained after the cooling.

Preferably, at first fatty acid derived from plant, polyalcohol and diacid(and/or their anhydride) are added into an agitated reactor equipped with an stirrer, a reflex condenser, a thermometer and the protection of nitrogen, and heated to the temperature between 160 and 260° C. and allowed to react for 0.5 to 6 hrs (preferably between 200 and 240° C. for 2 to 4 hrs). Water generated in the reaction is removed by a dehydrator. After the reactor is cooled to the temperature between 120 and 200° C., other polyacid(and/or their anhydride) are added, the resultant mixture is allowed to react for at least 0.5 hrs with heat preservation, and the water generated in the reaction is removed by a dehydrator. Optionally, 2 to 20 wt % (preferably 3 to 10 wt %) of rosin by the total weight of the resin is added when the reactor is cooled to the temperature between 130 and 160° C., and the resultant mixture is allowed to react for 5 mins to 2 hrs at the temperature, preferably 10 mins to 0.5 hrs. The prepolymer of alkyd with certain acid number is obtained after the cooling.

(2) Preparation of the Coating Agent of Water-Soluble Alkyd

The preparation of the coating agent of water-soluble alkyd in the invention includes the following steps:

mixing the prepolymer of alkyd with the cosolvent,

neutralizing the mixture obtained with the alkali,

optionally diluting the mixture obtained with water, and,

adding the drier.

In the preferred embodiment, the cosolvent at a proper ratio is added while stirring into the prepolymer of alkyd with the temperature of between 25 and 120° C. (preferably between 50 and 100° C.), preferably the usage amount of the cosolvent is 2 to 50 wt % by the weight of the prepolymer of alkyd, more preferably 5 to 20 wt %.

In the invention, the above-mentioned cosolvent is preferably selected from short-chain fatty alcohol, cellosolve, other water-soluble organic solvent, or a mixture thereof. The above-mentioned short-chain fatty alcohol is selected from C₂-C₆ monohydric alcohol, polyalcohol, or a mixture of thereof, such as ethanol, n-propanol, isopropanol, glycol, propylene glycol, n-butanol and sec-butyl alcohol. The above-mentioned cellosolve is preferably selected from monoether/diether of diol/diol acetal, or a mixture of thereof, such as ethylene glycol monomethyl ether, ethylene glycol monoethyl ether, ethylene glycol monobutyl ether, ethylene glycol dimethyl ether, ethylene glycol diethyl ether, diethylene glycol monomethyl ether, propylene glycol monomethyl ether, propylene glycol monoethyl ether, dipropylene glycol monomethyl ether, dipropylene glycol monoethyl ether, etc.. Other water-soluble organic solvent is preferably selected from acetone, butanone, pyrrolidone, THF, dioxane, or a mixture of thereof. The short-chain fatty alcohol and cellosolve are preferred.

The alkali used for neutralization is selected from any kind of conventional inorganic base or organic base, or a mixture of thereof, which contains alkali metal hydroxide, alkaline-earth hydroxide, amine, etc., such as sodium hydroxide, potassium hydroxide, ammonia, triethylamine, trimethylamine, triethanolamine, morpholine, preferably ammonia, triethylamine, trimethylamine, sodium hydroxide and potassium hydroxide. The aqueous solution of the above-mentioned alkali is preferably used. The solution of the above-mentioned prepolymer of alkyd is neutralized to the extent that its pH value reaches between 7 and 8.

If necessary, water can be further added in the neutral system, preferably deionized water and distilled water, and the water-soluble prepolymer of alkyd with different solid content is prepared as required.

By adding the drier into said system of the prepolymer of alkyd after neutralization under the room temperature, a water-soluble alkyd coating agent is obtained after stirring and mixing uniformly. Said drier is the drier which is known to those skilled in the art, which includes main drier and if necessary drier activator and/or drier active agent. Said main drier can be used separately, or used together with the drier activator and/or drier active agent, or a mixture thereof. The main drier is selected from cobalt salt, manganese salt, or a mixture thereof, preferably cobalt naphthenate or manganese naphthenate, and its usage amount is 0.005 to 0.5 wt % of the weight of the prepolymer of alkyd in the system, preferably 0.03 to 0.2 wt %. The drier activator is selected from lead salt, calcium salt, zinc salt, ferrum salt, barium salt, zirconium salt, or a mixture thereof, preferably naphthenate, and its usage amount is 0 to 0.5 wt % of the weight of the prepolymer of alkyd in the system, preferably 0.01 to 0.5 wt %. The drier active agent above mentioned is called as “active agent A” in present invention, which is the mixture of 38 wt % o-naphthisodiazine, 22 wt % ethyl caproate and 40 wt % n-butanol, and its usage amount is 0 to 2.0 wt % of the weight of the prepolymer of alkyd, preferably 0.05 to 1.0 wt %, and more preferably 0.1 to 0.8 wt %.

In present invention, the solid content of the said coating agent of water-soluble alkyd is 5 to 60 wt %, preferably 10 to 40 wt %, more preferably 15 to 30 wt %.

(3) Coated Controlled-Release Fertilizer and Method of Preparing the Same

In present invention, the fertilizer core can be any kind of the water-soluble fertilizer, which can be a single fertilizer, such as nitrogenous fertilizer like urea, phosphorus fertilizer like ammonium phosphate, potash fertilizer like potassium sulfate. Said fertilizer core can also be a compound fertilizer or mixed fertilizer of an arbitrary proportion of nitrogen, phosphorus and potassium, or other nutrient component of water-soluble plant.

In the preferred embodiment of the invention, the above-mentioned inorganic powder is selected from talcum powder, diatomite, montmorillonite, kaolin, calcium carbonate, bentonite, attapulgite, sepiolite powder, or a mixture of thereof, preferably talcum powder, diatomite and calcium carbonate, more preferably the micron-sized inorganic powder. The particle size of said inorganic powder is preferably less than 20 microns, more preferably less than 10 microns, most preferably less than 5 microns. The talcum powder, diatomite and calcium carbonate having a particle size less than 5 microns, are most preferred.

The preparation method for the water-soluble alkyd-sulfur coated controlled-release fertilizer of the invention includes the following coating process in a fluidized bed: firstly coating the surface of fertilizer particle with sulfur to form a sulfur film; then coating the surface of said sulfur film with a coating agent of water-soluble alkyd to form a polymer film, and optionally coating said polymer film with inorganic powder to form an inorganic layer. The above-mentioned coating process is preferably carried out in a fluidized bed in the form of a boiling type or rotating drum.

The coating process of sulfur in the invention can be carried out by any conventional coating manner in the art. In the more preferable embodiment, the molten liquid sulfur is sprayed on the fertilizer particle to form the sulfur film using the conventional coating technology in the fluidized bed in the art.

The coating agent of water-soluble alkyd in the invention is coated with the conventional coating technology in the art, preferably with coating technology in the fluidized-bed. The interior temperature of the fluidized-bed is preferably between 30 and 95° C.

In the further preferred embodiment, the fertilizer particle is added into a fluidized bed in the form of a boiling type or rotating drum; the fluidized bed is preheated, for example being preheated to the preferred temperature between 60 and 95° C. The sulfur is heated to be molten, and then the molten sulfur with the preferred temperature between 130 and 170° C. is sprayed onto the fertilizer particle to form a uniform sulfur film, preferably with the double nozzle. The thickness of the sulfur film can be adjusted as required, and for the same thickness of the sulfur film, the usage amount of sulfur differs due to the different size of fertilizer particle, the smaller the fertilizer particle is, the larger the usage amount of the sulfur is. The thickness of the sulfur film is usually controlled between 30 and 300 microns, preferably between 50 and 150 microns. The weight of said sulfur film is 5 to 30 wt % of the total weight of said fertilizer, preferably 7 to 20 wt %.

The sulfur-coated fertilizer particle is cooled down, preferably to the temperature between 60 and 95° C., and then the coating agent of water-soluble alkyd at room temperature(preferred preheated, for example being preheated to at most 80° C.), is sprayed uniformly onto the fertilizer particle coated by sulfur with a double nozzle, to form a continuous and uniform polymer film. In one more preferred embodiment, the coating agent of water-soluble alkyd is sprayed uniformly onto the surface of the sulfur-coated fertilizer particle with a double nozzle. The thickness of polymer film can be adjusted as required. In terms of the dry matter of polymer, the usage amount of said polymer is preferably 0.5 to 10 wt % of the total weight of said controlled-release fertilizer, more preferably 1 to 5 wt %.

If necessary, the inorganic powder is sprayed onto the fluidized-bed with preferred temperature between 30 and 95° C., more preferred 70 and 95° C., to make it uniformly coated on the surface of the fertilizer particle which is coated with polymer so as to form an inorganic layer. The usage amount of said inorganic powder is usually 0 to 10 wt % of the total weight of said coated controlled-release fertilizer, preferably 0.5 to 5 wt %, more preferably 1 to 3 wt %.

### EXAMPLES

The following examples are provided as further illustrations of present invention, which are intended to describe and not to limit the invention.

The vegetable oil, fatty acid, polyalcohol, polyacid, anhydride, drier, sulfur and inorganic powder used in the examples are of industrial grade; the alkali used is a chemical pure reagent, and the water used is deionized water.

The nutrient release period of the controlled-release fertilizer is expressed as a duration (days) from the immersion of the fertilizer into still water having a temperature of 25° C. to the nutrient release rate of up to 80 wt %. Specifically, a controlled-release fertilizer is immersed into still water with a temperature of 25° C., and the nutrient passes through the coating and is dissolved in the water. The total amount of dissolved nitrogen is determined by titration after distillation according to GB/T 8572. The total amount of dissolved phosphorus is determined by ammonium vanadate-molybdate colorimetry according to GB/T 8573. The total amount of dissolved potassium is determined by a flame photometer method according to GB/T 8574. The duration (days) from the immersion of the fertilizer into still water to the total nutrient release rate of up to 80 wt % is considered as the nutrient release period of the controlled-release fertilizer.

### Example 1

(1) Preparation of the Coating Agent of Water-Soluble Alkyd

480 g of linseed oil, 236 g of trimethylolpropane and 166 g of isophthalicacid were added into an agitated reactor equipped with a stirrer, a reflex condenser, a thermometer and the protection of nitrogen. The reactor was heated to 235° C., and the mixture was allowed to react for 3.5 hrs. Afterwards the reactor was cooled to 175° C., 73 g of trimellitic anhydride was added, and the resultant mixture was allowed to react for about 3 hrs at the temperature. The water generated in the reaction was removed by a dehydrator. When the acid number of the mixture arrived at 62 mgKOH/g resin, the system was cooled to the temperature of 150° C., and the resultant mixture was allowed to react for 20 mins after adding 49 g of rosin.

The above-mentioned system was cooled down. 70 g of the mixed solution consisting of ethylene glycol monobutyl ether and isopropanol (their weight ratio was 1:1.5) was added when the temperature of the system arrived at 70° C., and then the mixture in the reactor was mixed uniformly. When the temperature of the system dropped to below 50° C., the pH value of the resultant mixture was adjusted to between 7 and 8 with 15 wt % ammonia, and then the solid content of the resultant mixture was adjusted to 25 wt % with deionized water. At last 2.5 g of cobalt naphthenate, 2.2 g of zirconium naphthenate and 1 g of active agent A were added respectively, and the coating agent of water-soluble alkyd was obtained after it was mixed uniformly.

(2) Coating of Fertilizer

5 kg of urea (manufactured by Shandong Mingshui Chemical Co., Ltd., N wt %=46.4) having a particle size of 3 to 5 mm was added to a boiling-type fluidized bed, preheated to about 80° C., and then 0.6 kg of liquid sulfur melted and heated to about 145° C. was sprayed on the surface of the fertilizer particle with a double nozzle, with a spraying speed of 30 g/min. The sulfur-coated urea was cooled to about 80° C., and then 0.75 kg of above-mentioned coating agent of water-soluble alkyd which had been preheated to about 75° C. was sprayed on the surface of the sulfur-coated urea with another double nozzle, with a spraying speed of 20 g/min. Finally, 70 g of diatomite having an average particle size of 3 microns was sprayed uniformly on the surface of the fertilizer with the temperature of about 80° C.

Based on the dry weight of the composite coated controlled-release fertilizer obtained, the urea accounts for 85.9 wt %, the sulfur 10.3 wt %, the polymer 2.6 wt % and the diatomite 1.2 wt %. The nutrient release period of the controlled-release fertilizer was 148 days.

### Example 2

The same as that in Example 1, except replacing the urea in the Example 1 with the compound fertilizer (manufactured by Shandong Kingenta Ecological Engineering Co., Ltd., N—P₂O₅—K₂O wt %=16-16-16) having a particle size of 2 to 4 mm.

Based on the dry weight of the composite coated controlled-release fertilizer, the compound fertilizer accounts for 85.9 wt %, the sulfur 10.3 wt %, the polymer 2.6 wt % and the diatomite 1.2 wt %. The nutrient release period of the controlled-release fertilizer was 207 days.

### Example 3

(1) Preparation of the Coating Agent of Water-Soluble Alkyd

180 g of linseed oil, 220 g of dehydrated castor oil, 223 g of trimethylolpropane and 148 g of phthalic anhydride were added into an agitated reactor equipped with a stirrer, a reflex condenser, a thermometer and the protection of nitrogen. The reactor was heated to 225° C. and the mixture was allowed to react for 2.5 hrs. Afterwards the reactor was cooled to 170° C., 64 g of trimellitic acid was added, and the resultant mixture was allowed to react for about 3.5 hrs. The water generated in the reaction was removed by a dehydrator. When the acid number of the mixture arrived at 56 mgKOH/g resin, the reactor was cooled to the temperature of 160° C., and the resultant mixture was allowed to react for 15 mins after adding 60 g of rosin.

The above-mentioned system was cooled down. 55 g of the mixed solution consisting of ethylene glycol diethyl ether and n-butanol (their weight ratio was 1:2) was added when the temperature of the system arrived at 60° C., and then the mixture in the reactor was mixed uniformly. When the temperature of the system dropped to below 50° C., the pH value of the resultant mixture was adjusted to between 7 and 8 with 15 wt % ammonia, and then the solid content of the resultant mixture was adjusted to 25 wt % with deionized water. At last 2 g of cobalt naphthenate, 1.2 g of zirconium naphthenate and 1.5 g of active agent A were added respectively, and the coating agent of water-soluble alkyd was obtained after it was mixed uniformly.

(2) Coating of Fertilizer

5 kg of compound fertilizer (manufactured by Shandong Kingenta Ecological Engineering Co., Ltd., N—P₂O₅—K₂O wt %=16-16-16) having a particle size of 2 to 4 mm was added to a boiling-type fluidized bed, preheated to about 80° C., and then 0.5 kg of liquid sulfur melted and heated to about 140° C. was sprayed on the surface of the fertilizer particle with a double nozzle, with a spraying speed of 30 g/min. The sulfur-coated fertilizer was cooled to about 85° C., and then 0.5 kg of the coating agent of water-soluble alkyd which had been preheated to about 80° C. was sprayed on the surface of the sulfur-coated particle with another double nozzle, with a spraying speed of 20 g/min. Finally, 100 g of talcum powder having an average particle size of 3 microns was sprayed uniformly on the surface of the fertilizer with the temperature of about 80° C.

Based on the dry weight of the composite coated controlled-release fertilizer, the compound fertilizer accounts for 87.7 wt %, the sulfur 8.8 wt %, the polymer 1.8 wt % and the talcum powder 1.7 wt %. The nutrient release period of the controlled-release fertilizer was 132 days.

### Example 4

(1) Preparation of the Coating Agent of Water-Soluble Alkyd

221 g of linseed oil, 221 g of tung oil, 215 g of trimethylolpropane, 74 g of phthalic anhydride and 83 g of isophthalicacid were added into an agitated reactor equipped with a stirrer, a reflex condenser, a thermometer and the protection of nitrogen. The reactor was heated to 240° C. and the mixture was allowed to react for 2.5 hrs. Afterwards the reactor was cooled to 180° C., 49 g of trimellitic acid was added, and the resultant mixture was allowed to react for about 3 hrs. The water generated in the reaction was removed by a dehydrator. When the acid number of the mixture arrived at 46 mgKOH/g resin, the reactor was cooled to the temperature of 155° C., and the resultant mixture was allowed to react for 20 mins after adding 52 g of rosin.

The above-mentioned system was cooled down. 90 g of isopropanol was added when the temperature of the system arrived at 60° C., and then the mixture in the reactor was mixed uniformly. When the temperature of the system dropped to below 50° C., the pH value of the resultant mixture was adjusted to between 7 and 8 with 15 wt % ammonia, and then the solid content of the resultant mixture was adjusted to 20 wt % with deionized water. At last 1.8 g of cobalt naphthenate, and 2.5 g of active agent A were added respectively, and the coating agent of water-soluble alkyd was obtained after it was mixed uniformly.

(2) Coating of Fertilizer

5 kg of compound fertilizer (manufactured by Shandong Kingenta Ecological Engineering Co., Ltd., N—P₂O₅—K₂O wt %=15-15-15) having a particle size of 2 to 4 mm was added to a boiling-type fluidized bed, preheated to about 70° C., and then 0.75 kg of liquid sulfur melted and heated to about 150° C. was sprayed on the surface of the fertilizer particle with a double nozzle, with a spraying speed of 30 g/min. The sulfur-coated fertilizer was cooled to about 90° C., and then 0.75 kg of above-mentioned coating agent of water-soluble alkyd which had been preheated to about 80° C. was sprayed on the surface of the sulfur-coated particle with another double nozzle, with a spraying speed of 20 g/min. Finally, 100 g of talcum powder having an average particle size of 3 microns was sprayed uniformly on the surface of the fertilizer with the temperature of about 80° C.

Based on the dry weight of the composite coated controlled-release fertilizer, the compound fertilizer accounts for 83.3 wt %, the sulfur 12.5 wt %, the polymer 2.5 wt % and the talcum powder 1.7 wt %. The nutrient release period of the controlled-release fertilizer was 275 days.

### Example 5

The same as that in Example 4, except replacing the compound fertilizer in the Example 4 with the potassium sulphate (manufactured by Shandong Kingenta Ecological Engineering Co., Ltd., K₂O wt %=50) having a particle size of 3 to 5 mm.

Based on the dry weight of the composite coated controlled-release fertilizer, the potassium sulphate accounts for 83.3 wt %, the sulfur 12.5 wt %, the polymer 2.5 wt % and the talcum powder 1.7 wt %. The nutrient release period of the controlled-release fertilizer was 150 days.

### Example 6

The same as that in Example 4, except replacing the compound fertilizer in the Example 4 with the urea (manufactured by Shandong Mingshui Chemical Co., Ltd., N wt %=46.4) having a particle size of 3 to 5 mm.

Based on the dry weight of the water-soluble alkyd-sulfur composite coated controlled-release fertilizer, the urea accounts for 83.3 wt %, the sulfur 12.5 wt %, the polymer 2.5 wt % and the talcum powder 1.7 wt %. The nutrient release period of the controlled-release fertilizer was 172 days.

### Example 7

(1) Preparation of the Coating Agent of Water-Soluble Alkyd

290 g of tung oil, 135 g of bean oil, 112 g of trimethylolpropane, 70 g of pentaerythritol and 166 g of isophthalicacid were added into an agitated reactor equipped with a stirrer, a reflex condenser, a thermometer and the protection of nitrogen. The reactor was heated to 230° C. and the mixture was allowed to react for 3 hrs. Afterwards the reactor was cooled to 180° C., 49 g of trimellitic anhydride was added, and the resultant mixture was allowed to react for about 3 hrs at the temperature. The water generated in the reaction was removed by a dehydrator. When the acid number of the mixture arrived at 48 mgKOH/g resin, the reactor was cooled to the temperature of 155° C., and the resultant mixture was allowed to react for 20 mins after adding 52 g of rosin.

The above-mentioned system was cooled down. 70 g of the mixed solution consisting of ethylene glycol monoethyl ether and isopropanol (their weight ratio was 1:2) was added when the temperature of the system arrived at 50° C., and then the mixture in the reactor was mixed uniformly. When the temperature of the system dropped to below 50° C., the pH value of the resultant mixture was adjusted to between 7 and 8 with triethylamine, and then the solid content of the resultant mixture was adjusted to 20 wt % with deionized water; At last 1.5 g of cobalt naphthenate, 1.5 g of zirconium naphthenate and 2 g of active agent A were added respectively, and the coating agent of water-soluble alkyd was obtained after it was mixed uniformly.

(2) Coating of Fertilizer

5 kg of compound fertilizer (manufactured by Shandong Kingenta Ecological Engineering Co., Ltd., N—P₂O₅—K₂O wt %=16-16-16) having a particle size of 2 to 4 mm was added to a boiling-type fluidized bed, preheated to about 75° C., and then 0.65 kg of liquid sulfur melted and heated to about 155° C. was sprayed on the surface of the compound fertilizer particle with a double nozzle, with a spraying speed of 30 g/min. The sulfur-coated compound fertilizer was cooled to about 90° C., and then 0.625 kg of above-mentioned coating agent of water-soluble alkyd which had been preheated to about 85° C. was sprayed on the surface of the sulfur-coated compound fertilizer with another double nozzle, with a spraying speed of 15 g/min. Finally, 85 g of calcium carbonate having an average particle size of 3 microns was sprayed uniformly on the surface of the fertilizer with the temperature of about 85° C.

Based on the dry weight of the composite coated controlled-release fertilizer, the compound fertilizer accounts for 85.3 wt %, the sulfur 11.1 wt %, the polymer 2.1 wt % and the calcium carbonate 1.5 wt %. The nutrient release period of the controlled-release fertilizer was about 195 days.

### Example 8

The same as that in Example 7, except no spraying the calcium carbonate powder after the compound fertilizer particle was coated with sulfur and covered by a polymer film.

Based on the dry weight of the composite coated controlled-release fertilizer, the compound fertilizer accounts for 86.5 wt %, the sulfur 11.3 wt % and the polymer 2.2 wt %. The nutrient release period of the controlled-release fertilizer was about 170 days.

### Example 9

(1) Preparation of the Coating Agent of Water-Soluble Alkyd

83 g of isophthalicacid, 74 g of phthalic anhydride, 378 g of linoleic acid and 275 g of trimethylolpropane were added into an agitated reactor equipped with a stirrer, a reflex condenser, a thermometer and the protection of nitrogen. The reactor was heated to 240° C. and the mixture was allowed to react for 3.5 hrs. The water generated in the reaction was removed by a dehydrator. Afterwards the reactor was cooled to 185° C., 69 g of trimellitic anhydride was added, and the resultant mixture was allowed to react with heat preservation. The water generated in the reaction was removed by a dehydrator. The acid number of the mixture arrived at 57 mgKOH/g resin after about 4 hrs. When the reactor was cooled to the temperature of 150° C., 30 g of rosin was added and then the resultant mixture was allowed to react for 25 mins.

The above-mentioned system was cooled down. 60 g of the mixed solution consisting of ethylene glycol monobutyl ether and isopropanol (their weight ratio was 1:2) was added when the temperature of the system arrived at 50° C., and then the mixture in the reactor was mixed uniformly. When the temperature of the system dropped to below 50° C., the pH value of the resultant mixture was adjusted to between 7 and 8 with triethylamine, and then the solid content of the resultant mixture was adjusted to 20 wt % with deionized water; At last 2 g of cobalt naphthenate and 2.5 g of active agent A were added respectively, and the coating agent of water-soluble alkyd was obtained after it is mixed uniformly.

(2) Coating of Fertilizer

5 kg of compound fertilizer (manufactured by Shandong Kingenta Ecological Engineering Co., Ltd., N—P₂O₅—K₂O wt %=16-16-16) having a particle size of 2 to 4 mm was added to a boiling-type fluidized bed, preheated to about 80° C., and then 0.6 kg of liquid sulfur melted and heated to about 150° C. was sprayed on the surface of the compound fertilizer particle with a double nozzle, with a spraying speed of 30 g/min. The sulfur-coated compound fertilizer was cooled to about 85° C., and then 0.563 kg of above-mentioned coating agent of water-soluble alkyd which had been preheated to about 80° C. was sprayed on the surface of the sulfur-coated compound fertilizer with another double nozzle, with a spraying speed of 15 g/min. Finally, 80 g of calcium carbonate having an average particle size of 3 microns was sprayed uniformly on the surface of the fertilizer with the temperature of about 85° C.

Based on the dry weight of the composite coated controlled-release fertilizer, the compound fertilizer accounts for 86.3 wt %, the sulfur 10.4 wt %, the polymer 1.9 wt % and the calcium carbonate 1.4 wt %. The nutrient release period of the controlled-release fertilizer was 180 days.

1. A water-soluble alkyd-sulfur composite coated controlled-release fertilizer comprising a fertilizer core and a coating applied thereon, wherein said coating comprises a sulfur film and a polymer film comprising a coating agent of water-soluble alkyd outside the sulfur film, and optionally an inorganic layer comprising inorganic powder outside the polymer film.

2. The water-soluble alkyd-sulfur composite coated controlled-release fertilizer of claim 1, wherein the weight of said sulfur is 5 to 30 wt % of the total weight of said coated controlled-release fertilizer, preferably 8 to 20 wt %.

3. The water-soluble alkyd-sulfur composite coated controlled-release fertilizer of claim 1, wherein in terms of weight of dry matter, the weight of said polymer film is 0.5 to 10 wt % of the total weight of said coated controlled-release fertilizer, preferably 1 to 5 wt %.

4. The water-soluble alkyd-sulfur composite coated controlled-release fertilizer of claim 1, wherein the weight of said inorganic powder is 0 to 10 wt % of the total weight of said controlled-release fertilizer, preferably 0.5 to 5 wt %, more preferably 1 to 3 wt %.

5. The water-soluble alkyd-sulfur composite coated controlled-release fertilizer of claims 1, wherein said coating agent of water-soluble alkyd comprises the prepolymer of alkyd with neutralization.

6. The water-soluble alkyd-sulfur composite coated controlled-release fertilizer of claim 5, wherein the acid number of said prepolymer of alkyd is between 10 and 150 mgKOH/g resin, preferably between 20 and 120 mgKOH/g resin, more preferably between 30 and 80 mgKOH/g resin, further preferably between 40 and 70 mgKOH/g resin.

7. The water-soluble alkyd-sulfur composite coated controlled-release fertilizer of claim 5, wherein the solid content of said coating agent of water-soluble alkyd is 5 to 60 wt %, preferably 10 to 40 wt %, more preferably 15 to 30 wt %.

8. The water-soluble alkyd-sulfur composite coated controlled-release fertilizer of claim 5, wherein said prepolymer of alkyd is obtained through the copolycondensation of the raw material composition comprising vegetable oil and/or fatty acid derived from plant, polyalcohol and at least one component selected from C₄-C₂₂ synthetic fatty acid, anhydride of C₄-C₂₂ synthetic fatty acid, aromatic acid, and aromatic anhydride;
Wherein the usage amount of said vegetable oil and/or said fatty acid derived from plant is 30 to 70 wt % of the total weight of said raw material composition, more preferably 40 to 60 wt %; the molar ratio of hydroxyl to carboxyl in the raw material composition is preferably 0.8 to 1.4, more preferably 0.9 to 1.3.

9. The water-soluble alkyd-sulfur composite coated controlled-release fertilizer of claim 8, wherein said vegetable oil is selected from drying oil, semi-drying oil, or a mixture thereof, preferably linseed oil, tung oil, dehydrated castor oil, soybean oil, cottonseed oil and Naskole oil; said fatty acid derived from plant is selected from oleic acid, linoleic acid, linolenic acid, tall oil, rosin, or a mixture thereof; said polyalcohol is selected from glycerine, trimethylolpropane, pentaerythritol, sorbitol, diethylene glycol, or a mixture thereof; said C₄-C₂₂ synthetic fatty acid and their anhydride are selected from C₄-C₁₂ monoacid or polyacid or their anhydride, preferably C₄-C₂₂ diacid and their anhydride, especially adipic acid, decanedioic acid and their anhydride; said aromatic acid and their anhydride are selected from aromatic monoacid, aromatic diacid, aromatic triacid and their anhydride, especially phthalic anhydride, isophthalicacid, trimellitic acid and trimellitic anhydride.

10. The water-soluble alkyd-sulfur composite coated controlled-release fertilizer of claim 8, wherein the preparation method of said prepolymer of alkyd is alcoholysis method or fatty acid process, preferably alcoholysis method.

11. The water-soluble alkyd-sulfur composite coated controlled-release fertilizer of claim 8, wherein said copolycondensation is solution copolycondensation or melt copolycondensation, preferably melt copolycondensation.

12. The water-soluble alkyd-sulfur composite coated controlled-release fertilizer of claim 8, wherein the temperature of the copolycondensation reaction is between 100 and 280° C., preferably between 140 and 250° C.; the time of the copolycondensation reaction is between 1 and 24 hrs, preferably between 4 and 12

13. The water-soluble alkyd-sulfur composite coated controlled-release fertilizer of claims 1, wherein said inorganic powder is selected from talcum powder, diatomite, montmorillonite, kaolin, calcium carbonate, bentonite, attapulgite, sepiolite powder, or a mixture of thereof, preferably talcum powder, diatomite and calcium carbonate, more preferably the micron-sized inorganic powder, preferably the inorganic powder having a particle size less than 5 microns, further preferably the talcum powder, diatomite and calcium carbonate having a particle size less than 5 microns.

14. A method of preparing the coating agent of water-soluble alkyd of claims 1, includes the following steps:
mixing the prepolymer of alkyd with the cosolvent,
neutralizing the mixture obtained with the alkali,
optionally diluting the mixture obtained with water, and
adding the drier.

15. The method of preparing the coating agent of water-soluble alkyd of claim 14, wherein said cosolvent is selected from short-chain fatty alcohol, cellosolve, other water-soluble organic solvent, or a mixture thereof; said short-chain fatty alcohol is selected from C₂-C₆ monohydric alcohol, polyalcohol, or a mixture of thereof, such as ethanol, n-propanol, isopropanol, glycol, propylene glycol, n-butanol and sec-butyl alcohol; said cellosolve is selected from monoether/diether of diol/diol acetal, or a mixture of thereof, such as ethylene glycol monomethyl ether, ethylene glycol monoethyl ether, ethylene glycol monobutyl ether, ethylene glycol dimethyl ether, ethylene glycol diethyl ether, diethylene glycol monomethyl ether, propylene glycol monomethyl ether, propylene glycol monoethyl ether, dipropylene glycol monomethyl ether, dipropylene glycol monoethyl ether, etc.; said other water-soluble organic solvent is selected from acetone, butanone, pyrrolidone, THF, dioxane, or a mixture of thereof; the short-chain fatty alcohol and cellosolve are preferred; preferably the usage amount of the cosolvent is 2 to 50 wt % by the weight of the prepolymer of alkyd, more preferably 5 to 20 wt %.

16. The method of preparing the coating agent of water-soluble alkyd of claim 14, wherein said alkali is inorganic base or organic base, or a mixture of thereof, preferably alkali metal hydroxide, alkaline-earth hydroxide and amine; more preferably ammonia, triethylamine, trimethylamine, sodium hydroxide and potassium hydroxide.

17. The method of preparing the coating agent of water-soluble alkyd of claim 14, wherein said drier includes main drier and optionally drier activator and/or drier active agent.

18. The method of preparing the coating agent of water-soluble alkyd of claim 17, wherein said main drier is selected from cobalt salt, manganese salt, or a mixture thereof, preferably cobalt naphthenate or manganese naphthenate, preferably its usage amount is 0.005 to 0.5 wt % of the weight of the prepolymer of alkyd; said drier activator is selected from lead salt, calcium salt, zinc salt, ferrum salt, barium salt, zirconium salt, or a mixture thereof, preferably its usage amount is 0 to 0.5 wt % of the weight of the prepolymer of alkyd, preferably 0.01 to 0.5 wt %; said drier active agent is the mixture of 38 wt % o-naphthisodiazine, 22 wt % ethyl caproate and 40 wt % n-butanol, and its usage amount is 0 to 2.0 wt % of the weight of the prepolymer of alkyd, preferably 0.05 to 1.0 wt %.

19. A method of preparing the water-soluble alkyd-sulfur composite coated controlled-release fertilizer of claim 1, includes the following coating process in a fluidized bed, preferably in a fluidized bed in the form of a boiling type or rotating drum: firstly coating the surface of fertilizer particle with sulfur to form a sulfur film; then coating the surface of said sulfur film with a coating agent of water-soluble alkyd to form a polymer film, and optionally coating said polymer film with inorganic powder to form an inorganic layer.
